(19) United States
(12) Patent Application Publication
(10) Pub. No.: US 2025/0328045 A1
(43) Pub. Date: Oct. 23, 2025

(54) ELECTRONIC DEVICE

(71) Applicant: InnoLux Corporation, Miao-Li County (TW)

(72) Inventors: Chih-Chin KUO, Miao-Li County (TW); En-Hsiang CHEN, Miao-Li County (TW); Hsu-Kuan HSU, Miao-Li County (TW)

(21) Appl. No.: 19/088,004

(22) Filed: Mar. 24, 2025

(30) Foreign Application Priority Data
Apr. 19, 2024 (CN) 202410473636.1

(51) Int. Cl. G02F 1/1335; G02F 1/1333; G02F 1/13363; G02F 1/137

(52) U.S. Cl. CPC G02F 1/133536; G02F 1/133382; G02F 1/133638; G02F 1/13718

(57) ABSTRACT

An electronic device includes: a reflective polarizing element; an infrared light reflective element disposed opposite to the reflective polarizing element; a quarter wave plate disposed between the reflective polarizing element and the infrared light reflective element; and a light modulation element disposed between the quarter wave plate and the infrared light reflective element.

### CROSS-REFERENCE TO RELATED APPLICATIONS

This application claims the benefits of the Chinese Patent Application Ser. No. 202410473636.1, filed on Apr. 19, 2024, the subject matter of which is incorporated herein by reference.

### BACKGROUND

### Field

The present disclosure relates to an electronic device and, more particularly an electronic device comprising a light modulation element.

### Description of Related Art

In recent years, as environmental protection awareness has gradually gained attention, various energy-saving products have been produced in response, such as electronic devices for smart windows or other applications that can control the degree of light transmission (transmitting state, dark state, haze state, etc. that the light transmittance is changed).

However, since materials that can control the light transmitting state (such as the liquid crystal material) are difficult to effectively control outside the operating temperature range. When this type of electronic device is used in high latitudes or low temperature environments, additional heating devices are required to ensure that the materials in the electronic device are maintained within a suitable operating temperature range, resulting in limited energy saving effects.

Therefore, it is desirable to provide an electronic device to improve the conventional defects.

### SUMMARY

The present disclosure provides an electronic device, comprising: a reflective polarizing element; an infrared light reflective element disposed opposite to the reflective polarizing element; a quarter wave plate disposed between the reflective polarizing element and the infrared light reflective element; and a light modulation element disposed between the quarter wave plate and the infrared light reflective element.

Other novel features of the disclosure will become more apparent from the following detailed description when taken in conjunction with the accompanying drawings.

### BRIEF DESCRIPTION OF DRAWINGS

FIG. 1A is a schematic view of an electronic device according to one embodiment of the present disclosure.

FIG. 1B is a schematic view showing the reflection axis, the transmitting axis and the fast axis of each components of an electronic device according to one embodiment of the present disclosure.

FIG. 2A is a schematic view showing the IR reflective mode of an electronic device according to one embodiment of the present disclosure.

FIG. 2B is a schematic view showing the IR transmitting mode of an electronic device according to one embodiment of the present disclosure.

FIG. 2C is a schematic view showing the IR reflective mode of an electronic device according to one embodiment of the present disclosure.

FIG. 2D is a schematic view showing the IR transmitting mode of an electronic device according to one embodiment of the present disclosure.

FIG. 3A is a schematic view showing the IR reflective mode of an electronic device according to one embodiment of the present disclosure.

FIG. 3B is a schematic view showing the IR transmitting mode of an electronic device according to one embodiment of the present disclosure.

### DETAILED DESCRIPTION

The following is a detailed description of the electronic device according to the embodiment of the present disclosure. It should be understood that the following description provides many different embodiments for implementing different aspects of some embodiments of the present disclosure. Specific examples of each component and its configuration are described below to simplify the embodiments of the present disclosure. Of course, these are only examples and are not intended to limit the present disclosure. In addition, similar and/or corresponding reference numerals may be used to identify similar and/or corresponding elements in different embodiments to clearly describe the present disclosure. However, the use of these similar and/or corresponding reference numerals is only for the purpose of simply and clearly describing some embodiments of the present disclosure, and does not imply any correlation between the different embodiments and/or structures discussed.

It should be understood that relative terms, such as “lower” or “bottom” or “higher” or “top” may be used in the embodiments to describe the relative relationship of one element to another element illustrated in the drawings. It will be understood that if the device in the figures is turned upside down, elements described as being on the “lower” side would then be elements described as being on the “upper” side. The embodiments of the present disclosure can be understood together with the drawings, and the drawings of the present disclosure are also regarded as part of the disclosure description. It should be understood that the drawings of the present disclosure are not drawn to scale and, in fact, the dimensions of elements may be arbitrarily enlarged or reduced in order to clearly illustrate the features of the present disclosure.

One structure (or layer, component, or substrate) described in the present disclosure is located on/above another structure (or layer, component, or substrate). This may mean that the two structures are adjacent and directly connected, or the two structures are adjacent rather than directly connected. Indirect connection means that there is at least one intermediary structure (or intermediary layer, intermediary component, intermediary substrate, or intermediary spacer) between two structures. The lower surface of one structure is adjacent to or directly connected to the upper surface of the intermediary structure, and the upper surface of another structure is adjacent to or directly connected to the lower surface of the intermediary structure. The intermediary structure can be composed of a single-layer or multi-layer solid structure or a non-solid structure, and there is no limit. In the present disclosure, when a structure is disposed “on” another structure, it may mean that the structure is “directly” on the other structure, or that the structure is “indirectly” on the other structure, that is, at least one structure is also sandwiched between the structure and the other structure.

In addition, it should be understood that the ordinal numbers used in the description and the claims, such as “first”, “second”, etc., are intended only to describe the elements claimed and imply or represent neither that the (these) elements have any proceeding ordinals, nor that sequence between one claimed element and another claimed element or between steps of a manufacturing method. The use of these ordinals is merely to differentiate one claimed element having a certain designation from another claimed element having the same designation. The same words may not be used in the claim and the description. For example, the first element in the description may be the second element in the claim.

In some embodiments of the present disclosure, terms related to joining and connecting, such as “connection”, “interconnection”, etc., unless otherwise defined, may mean that two structures are in direct contact, or may also mean that two structures are not in direct contact where other structures are located between these two structures. The terms “joint” and “connection” can also include situations where both structures are movable, or where both structures are fixed. In addition, the terms “electrical connection” or “coupling” include any direct and indirect means of electrical connection.

The terms, such as “about”, “substantially”, or “approximately”, are generally interpreted as within 10%, 5%, 3%, 2%, 1%, or 0.5% of a given value or range. Unless otherwise stated, when a value is “in a range from a first value to a second value” or “in a range between a first value and a second value”, the value can be the first value, the second value, or another value between the first value and the second value. In addition, any two values or directions used for comparison may have certain errors. If the first value is equal to the second value, it implies that there may be an error of about 10% between the first value and the second value. If the first direction is perpendicular to the second direction, the angle between the first direction and the second direction may be between 80° and 100°. If the first direction is parallel to the second direction, the angle between the first direction and the second direction may be between 0° and 10°. In the present disclosure, the term “the given range is from the first value to the second value” and “the given range falls within the range of the first value to the second value” mean that the given range includes the first value, the second value and another value between the first value and the second value.

Furthermore, according to embodiments of the present disclosure, optical microscopy (OM), scanning electron microscope (SEM), film thickness profile measuring instrument (α-step), ellipsometer, or other suitable methods are to measure the thickness, length or width of each component or the distance and angle between components. Specifically, according to some embodiments, a scanning electron microscope can be used to obtain cross-sectional images of the structure and to measure the thickness, length, width, or distance and angle between components.

In the specification and the appended claims of the present disclosure, certain words are used to refer to specific elements. Those skilled in the art should understand that electronic device manufacturers may refer to the same components by different names. The present specification does not intend to distinguish between elements that have the same function but have different names. In the following description and claims, words such as “comprising”, “including”, “containing”, and “having” are open-ended words, so they should be interpreted as meaning “containing but not limited to . . . ”. Therefore, when the terms “comprising”, “including”, “containing” and/or “having” are used in the description of the present disclosure, they specify the existence of corresponding features, regions, steps, operations and/or components, but do not exclude the existence of one or more corresponding features, regions, steps, operations and/or components.

In the present specification, except otherwise specified, the terms (including technical and scientific terms) used herein have the meanings generally known by a person skilled in the art. It should be noted that, except otherwise specified in the embodiments of the present disclosure, these terms (for example, the terms defined in the generally used dictionary) should have the meanings identical to those known in the art, the background of the present disclosure or the context of the present specification, and should not be read by an ideal or over-formal way. The present disclosure may be understood by referring to the following detailed description in conjunction with the accompanying drawings. It should be noted that, for the sake of ease of understanding for readers and simplicity of the drawings, many of the drawings in the present disclosure only depict a portion of an electronic device, and specific components in the drawings are not drawn according to actual scale. In addition, the number and size of each component in the figures are only for illustration and are not intended to limit the scope of the present disclosure.

In the specification and the appended claims of the present disclosure, certain words are used to refer to specific elements. Those skilled in the art should understand that electronic device manufacturers may refer to the same components by different names. The present specification does not intend to distinguish between elements that have the same function but have different names.

The electronic device of the present disclosure may include electronic components, and the electronic components can include passive components, active components or a combination thereof, such as capacitors, resistors, inductors, varactor diodes, variable capacitors, filters, diodes, transistors, sensors, microelectromechanical system components (MEMS), liquid crystal chips, etc., but the present disclosure is not limited thereto. The diode may include light emitting diode or non-light emitting diode. The diode includes a P-N junction diode, a PIN diode or a constant current diode. The light emitting diode may include, for example, an organic light emitting diode (OLED), a mini LED, a micro LED, a quantum dot LED, fluorescence, phosphors, other suitable material or a combination thereof, but the present disclosure is not limited thereto. The sensor may include, for example, a capacitive sensor, an optical sensor, an electromagnetic sensor, a fingerprint sensor (FPS), a touch sensor, an antenna or a pen sensor, but the present disclosure is not limited thereto. In the following, a display device will be used as an electronic device to illustrate the content of the present disclosure, but the present disclosure is not limited thereto.

The electronic device may include an imaging device, a laminating device, a display device, a backlight device, an antenna device, a tiled device, a touch electronic device (a touch display), a curved electronic device (a curved display) or a non-rectangular electronic device (a free shape display), but the present disclosure is not limited thereto. The electronic device may include liquid crystals, light emitting diodes, fluorescence, phosphors, other suitable display media, or a combination thereof, but the present disclosure is not limited thereto. The display device may be a non-self-luminous display device or a self-luminous display device. The antenna device may be a liquid crystal antenna device or a non-liquid crystal antenna device. The sensing device may be a sensing device that can sense capacitance, light, heat energy or ultrasonic waves. But, the present disclosure is not limited thereto. The tiled device may be, for example, a tiled display device or a tiled antenna device, but is not limited thereto. It should be noted that the electronic device may be any permutation and combination of the above, but is not limited thereto. The electronic device may be a bendable or flexible electronic device. It should be noted that the electronic device may be any permutation and combination of the above, but not limited to this. In addition, the shape of the electronic device may be rectangular, circular, polygonal, or having a shape with curved edges or other suitable shapes. The electronic device may have peripheral systems such as drive systems, control systems, light source systems, shelf systems, etc. to support the display device, the antenna device or the tiled device.

In the present disclosure, infrared light, for example, refers to light with wavelengths between 780 nm and 3000 nm (780 nm≤wavelength≤3000 nm); ultraviolet light, for example, refers to light with wavelengths between 10 nm and 380 nm (10 nm≤wavelength<380 nm); visible light, for example, refers to light with wavelengths between 380 nm and 780 nm (380 nm≤wavelength<780 nm).

It should be noted that the following embodiments can be replaced, reorganized, and mixed with features in several different embodiments to complete other embodiments without departing from the spirit of the present disclosure. The features of various embodiments can be mixed and matched arbitrarily as long as they do not violate or conflict the spirit of the invention. It should be noted that the technical solutions provided in different embodiments below can be replaced, combined or mixed with each other to form another embodiment without violating the spirit of the present disclosure.

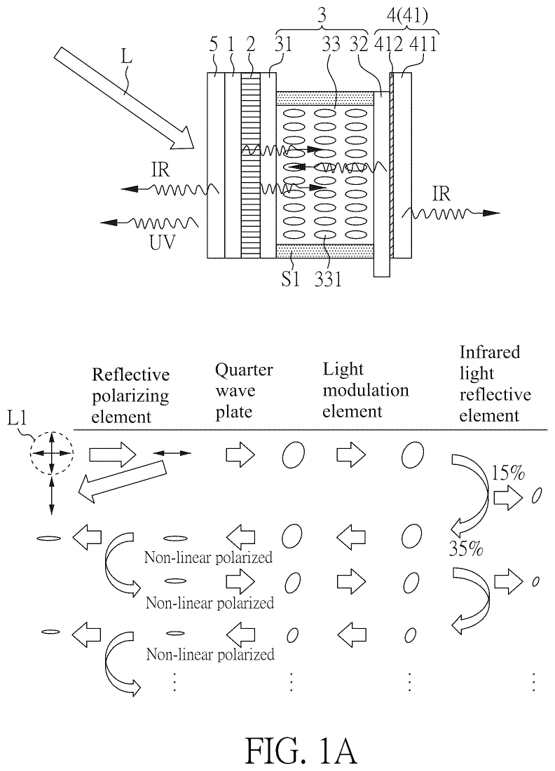

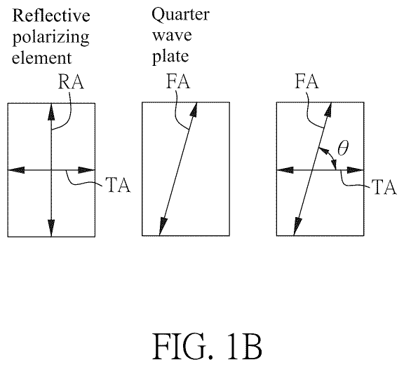

FIG. 1A is a schematic view of an electronic device according to one embodiment of the present disclosure. FIG. 1B is a schematic view showing the reflection axis, the transmitting axis and the fast axis of each components of an electronic device according to one embodiment of the present disclosure.

In one embodiment of the present disclosure, as shown in FIG. 1A, the electronic device may comprise: a reflective polarizing element 1; an infrared light reflective element 4 disposed opposite to the reflective polarizing element 1; a quarter wave plate 2 disposed between the reflective polarizing element 1 and the infrared light reflective element 4; and a light modulation element 3 disposed between the quarter wave plate 2 and the infrared light reflective element 4. Through the above design, infrared light (IR) can be recycled in the electronic device, and the light modulation element 3 can still be heated without additional heating devices to achieve energy saving purposes.

In one embodiment of the present disclosure, the reflective polarizing element 1 may comprise, for example, a polarizer with reflective function, but the present disclosure is not limited thereto. In one embodiment of the present disclosure, the reflective polarizing element 1 may be used, for example, to reflect at least part of light with wavelengths between 780 nm and 3000 nm (780 nm≤wavelength≤3000 nm), but the present disclosure is not limited thereto. In one embodiment, the reflectivity of the reflective polarizing element 1 to light with wavelengths between 780 nm and 3000 nm (780 nm≤wavelength≤3000 nm) may be between 5% and 50% (5%≤reflectivity≤50%) or between 10% and 50% (10%≤reflectivity≤50%), but the present disclosure is not limited thereto. In one embodiment of the present disclosure, as shown in FIG. 1B, the reflective polarizing element 1 has a transmitting axis TA and a reflection axis RA approximately perpendicular to the transmitting axis TA. The incident light (the incident light with wavelengths between 780 nm and 3000 nm) parallel to the transmitting axis TA mostly penetrates through the reflective polarizing element 1, and the incident light (the incident light with wavelengths between 780 nm and 3000 nm) parallel to the reflection axis RA is mostly reflected.

In one embodiment of the present disclosure, as shown in FIG. 1B, the wave plate 2 (for example, the quarter wave plate) has a fast axis FA. In one embodiment, as shown in FIG. 1B, an angle θ is included between the transmitting axis TA of the reflective polarizing element 1 and the fast axis FA of the quarter wave plate 2, and the angle θ is greater than 0° and less than 45° (0°<θ<45°) or greater than 45° and less than 90° (45°<θ<90°). For example, the angle θ is greater than 5° and less than or equal to 40° (5°≤θ≤40°) or greater than 50° and less than 85° (50°≤θ≤85°). For example, the angle θis greater than 10° and less than 35° (10°≤θ≤35°) or greater than 55° and less than 80° (55°≤θ≤80°). Since the quarter wave plate 2 has a phase retardation function, when the angle θ between the transmitting axis TA of the reflective polarizing element 1 and the fast axis FA of the quarter wave plate 2 meets the above design, most of the linearly polarized light can be approximately converted into elliptically polarized light after passing through the quarter wave plate 2.

In one embodiment of the present disclosure, as shown in FIG. 1A, the light modulation element 3 may comprise: a first substrate 31; a second substrate 32 disposed opposite to the first substrate 31; and a light modulation layer 33 disposed between the first substrate 31 and the second substrate 32, but the present disclosure is not limited thereto. The light modulation layer 33 may comprise a liquid crystal material 331 capable of switching between the transmitting state and the scattering state. Thus, the light modulation element 3 can be switched between the transmitting state and the haze state, and the electronic device can be applied to, for example, smart windows or other suitable applications.

In one embodiment of the present disclosure, the materials of the first substrate 31 and the second substrate 32 may be the same or different, and the materials of the first substrate 31 and the second substrate 32 may respectively comprise glass, quartz, sapphire, ceramics, polycarbonate (PC), polyimide (PI), polyethylene terephthalate (PET), polymethylmethacrylate (PMMA), triacetate cellulose (TAC), other suitable substrate materials or a combination thereof, but the present disclosure is not limited thereto. In one embodiment of the present disclosure, the light modulation layer 33 may comprise a guest-host liquid crystal (GHLC), that is, the light modulation element comprise a liquid crystal material 331 and a dye material. The dye material may comprise a dichroic dye, and the dye material may be, for example, used to absorb at least part of light with wavelengths between 360 nm and 830 nm, but the present disclosure is not limited thereto. The color of the dye material may be, for example, black, purple, orange, blue, other suitable colors or a combination thereof, but the present disclosure is not limited thereto. The dye material with different colors can be used to absorb at least part of light with different wavelengths (for example, visible light of different wavelengths) to control the color of the transmitting light. In one embodiment of the present disclosure, the liquid crystal material 331 may comprise a polymer-dispersed liquid crystal (PDLC), a polymer network liquid crystal (PNLC), a cholesteric texture liquid crystal, a twisted nematic liquid crystal (TN LC), a super twisted nematic liquid crystal (STN LC), other suitable liquid crystal material or a combination thereof, but the present disclosure is not limited thereto. In one embodiment of the present disclosure, operating temperature range of the liquid crystal material 331 may be between −45° C. and 85° C. (−45° C.≤operating temperature range≤85° C.), between −35° C. and 75° C. (−35° C.≤operating temperature range≤75° C.) or between −25° C. and 65° C. (−25° C.≤operating temperature range≤65° C.), but the present disclosure is not limited thereto. The operating temperature range may be the temperature range that the liquid crystal material 331 is affected by an electric field and the arrangement thereof can be adjusted normally.

In one embodiment of the present disclosure, as shown in FIG. 1A, the light modulation element 3 may comprise a sealing element S1, which may disposed surrounding the light modulation layer 33.

In one embodiment of the present disclosure, even not shown in the figure, the light modulation element 3 may selectively comprise an electrode layer, a conductive layer, an alignment layer, a spacer, an active element, a passive element or other suitable element, and conventional materials known in the art can be used to prepare the above components and are not described again.

In one embodiment of the present disclosure, the reflectivity of the infrared light reflective element 4 to light with wavelengths between 780 nm and 3000 nm (780 nm≤wavelength≤3000 nm) may be greater than or equal to 70%, for example, the reflectivity thereof may be between 70% and 95% (70%≤reflectivity≤95%), between 70% and 90% (70%≤reflectivity≤90%), between 70% and 85% (70%≤reflectivity≤85%), between 70% and 80% (70%≤reflectivity≤80%), but the present disclosure is not limited thereto. In one embodiment, as shown in FIG. 1A, the infrared light reflective element 4 may comprise a low emissivity glass 41 (Low-E glass), and the transmittance of the low emissivity glass 41 to light with wavelengths between 780 nm and 3000 nm (780 nm≤wavelength≤3000 nm) may be between 5% and 35% (5%≤transmittance≤35%) or between 10% and 30% (10%≤transmittance≤30%), but the present disclosure is not limited thereto. In one embodiment of the present disclosure, the transmittance of the low emissivity glass 41 to visible light (for example, the light with wavelengths between 380 nm and 760 nm (380 nm≤wavelength≤760 nm)) may be between 50% and 90% (50%≤transmittance≤90%) or between 45% and 85% (45%≤transmittance≤85%). In one embodiment of the present disclosure, as shown in FIG. 1A, the low emissivity glass 41 may comprise a substrate 411 and a coating layer 412 disposed on the substrate 411, wherein the coating layer 412 can be used to reflect at least part of light with wavelengths between 780 nm and 3000 nm (780 nm≤wavelength≤3000 nm), between 780 nm and 2800 nm (780 nm≤wavelength≤2800 nm) or between 780 nm and 2500 nm (780 nm≤wavelength≤2500 nm), but the present disclosure is not limited thereto. In one embodiment, the coating layer 412 may be disposed on one side of the substrate 411 adjacent to the light modulation element 3. However, in other embodiments, the coating layers 412 may be respectively disposed on one side of the substrate 411 adjacent to the light modulation element 3 and the other side of the substrate 411 far away from the light modulation element 3. The substrate 411 may comprise a rigid substrate or a flexible substrate. The material of the substrate 411 comprise but not limited to glass, quartz, sapphire, ceramics, polycarbonate (PC), polyimide (PI), polyethylene terephthalate (PET), polymethylmethacrylate (PMMA), triacetylcellulose (TAC), other suitable substrate material or a combination thereof. Suitable material for the coating layer 412 comprises but not limited to silver, aluminum, other metal material, an alloy thereof or a combination thereof. The coating layer 412 can be composed of a single layer, a double layer or greater than two layers of coating materials, and the material of each coating layer may be the same or different.

In one embodiment, as shown in FIG. 1A, the electronic device may comprise an optical element 5, and the optical element 5 may be disposed on a side of the reflective polarizing element 1 away from the light modulation element 3, and the reflective polarizing element 1 is disposed between the optical element 5 and the light modulation element 3. More specifically, the optical element 5 is closer to the incident light L than the light modulation element 3, and the optical element 5 may be used to reduce at least part of ultraviolet (UV) light entering the light modulation element 3, thereby reducing the damage caused by UV light to the liquid crystal material 331 in the light modulation element 3. In one embodiment, the optical element 5 may comprise an anti-UV coating layer.

In one embodiment of the present disclosure, even not shown in the figure, an adhesive layer (not shown in the figure) may be selectively disposed between two adjacent of the reflective polarizing element 1, the quarter wave plate 2, the light modulation element 3, the infrared light reflective element 4 and/or the optical element 5 to fix the components disposed on two sides of the adhesive layer. The material of the adhesive layer may comprise polyvinyl butyral (PVB), ethylene vinyl acetate (EVA), optical clear adhesive (OCA), optical clear resin (OCR), other suitable material or a combination thereof, but the present disclosure is not limited thereto.

The situation in which infrared light (IR) passes through an electronic device will be described in detail below. In FIG. 1A, the horizontal bidirectional arrow represents horizontally polarized light, the vertical bidirectional arrow represents vertically polarized light, and the ellipse represents elliptically polarized light. In the following embodiments, only infrared light is explained. The incident light L can include infrared light L1, ultraviolet light and/or visible light. The reflective polarizing element 1, for example, may be used to reflect about 50% of infrared light and allow about 50% of infrared light to pass through. The infrared light reflective element 4, for example, may be used to reflect about 70% of infrared light and allow about 30% of infrared light to pass through. But, the present disclosure is not limited thereto. The amounts of the infrared light reflected by or passing through the reflective polarizing element 1 and the infrared light reflective element 4 may be respectively adjusted according to different designs.

In one embodiment of the present disclosure, as shown in FIG. 1A and FIG. 1B, when incident infrared light L1 (for example, including horizontally polarized light and vertical polarized light) passes through the reflective polarizing element 1, the vertically polarized light (approximately about 50% of the incident infrared light L1) approximately parallel to the reflection axis RA of the reflective polarizing element 1 can be mostly reflected, and the horizontally polarized light (approximately about 50% of the infrared light L1) approximately parallel to the transmitting axis TA of the reflective polarizing element 1 can mostly pass through the reflective polarizing element 1 and further transmit to the quarter wave plate 2. Next, the horizontally polarized light passing through the reflective polarizing element 1 is affected by, for example, the phase retardation of the quarter wave plate 2, and at least part thereof is converted from linearly polarized light into elliptically polarized light. Then, after most of the elliptically polarized light (infrared light) passes through the light modulation element 3, most of the elliptically polarized light (infrared light), for example, is at least partially reflected by the infrared light reflective element 4, and the rest part of the elliptically polarized light (infrared light), for example, passes through the infrared light reflective element 4. The reflected elliptically polarized light may be about 35% of the incident infrared light L1, and the passing elliptically polarized light is about 15% of the incident infrared light L1; but the present disclosure is not limited thereto.

Next, at least part of the reflected elliptically polarized light (infrared light) may pass through the light modulation element 3 and the quarter wave plate 2 in sequence. The light (infrared light) passing through the quarter wave plate 2 is affected by the phase retardation, and at least part of the elliptically polarized light is converted into non-linear polarized light. Then, most of the light (infrared light) in the non-linear polarized light approximately parallel to the transmitting axis TA of the reflective polarizing element 1 may pass through the reflective polarizing element 1 to leave the electronic device, and the light (infrared light) approximately parallel to the reflection axis RA of the reflective polarizing element 1 is reflected and circulated inside the electronic device. The light (infrared light) approximately parallel to the reflection axis RA of the reflective polarizing element 1, for example, passes through the quarter wave plate 2, the light modulation element 3 and the infrared light reflective element 4 in sequence, and continuously circulated inside the electronic device as mentioned above. At least part of the liquid crystal material 331 of the light modulation element 3 can be, for example, continuously heated by the infrared light. Even no heating device is installed, the liquid crystal material 331 is maintained within the operating temperature range to achieve energy saving.

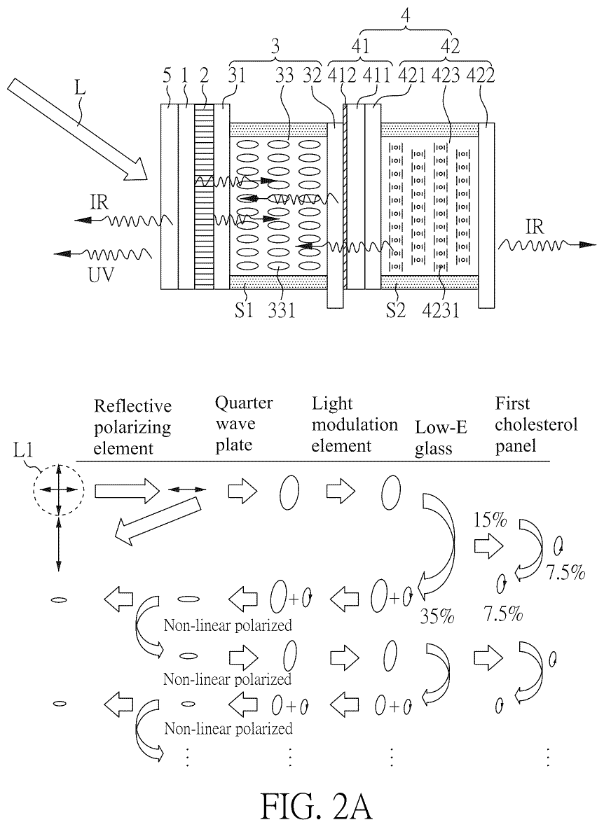

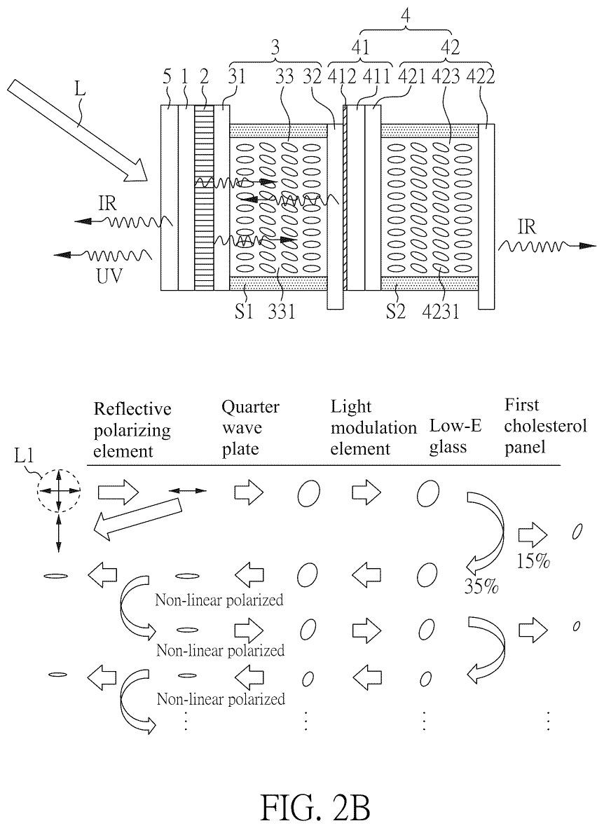

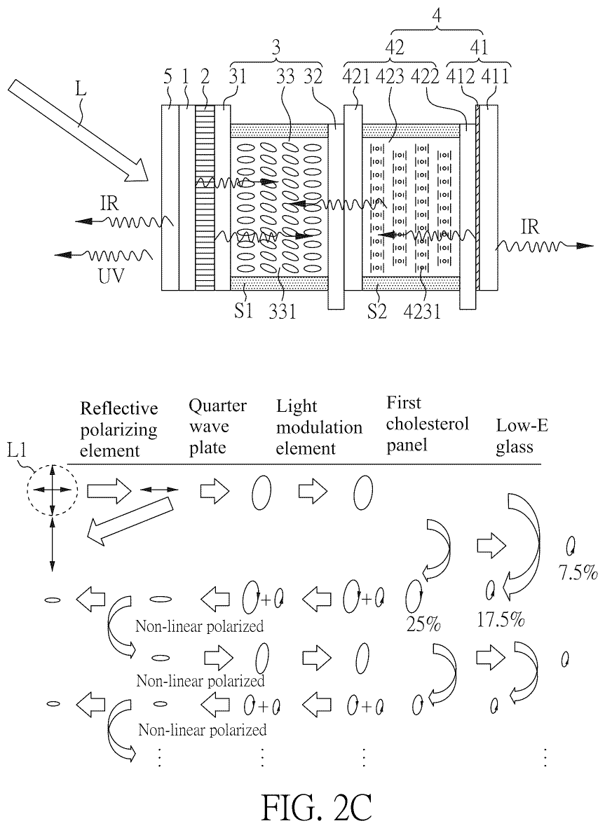

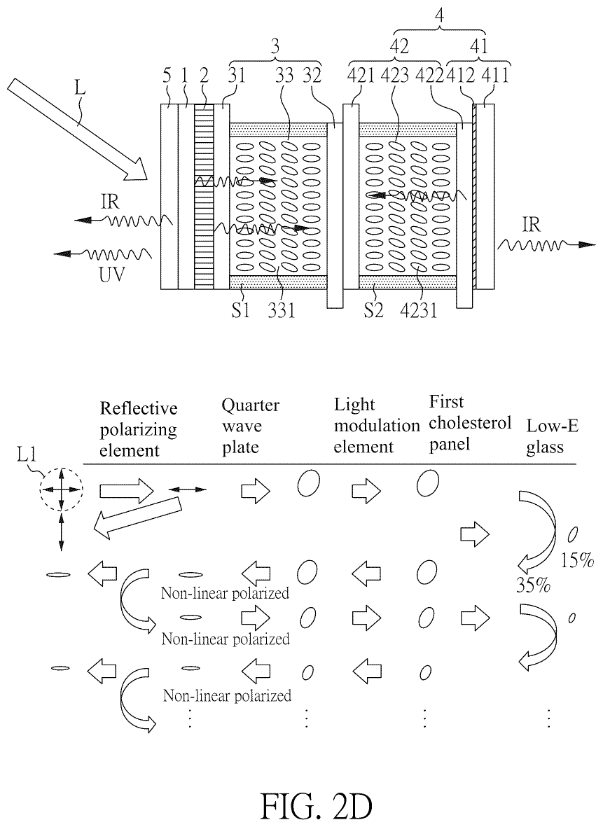

FIG. 2A is a schematic view showing the IR reflective mode of an electronic device according to one embodiment of the present disclosure. FIG. 2B is a schematic view showing the IR transmitting mode of an electronic device according to one embodiment of the present disclosure. The electronic device shown in FIG. 2A and FIG. 2B is similar to that shown in FIG. 1A except for the following difference.

In one embodiment of the present disclosure, as shown in FIG. 2A and FIG. 2B, the infrared light reflective element 4 comprises: a low emissivity glass 41; and a first cholesterol panel 42 disposed opposite to the low emissivity glass 41, wherein the low emissivity glass 41 is disposed between the first cholesterol panel 42 and the light modulation element 3. The first cholesterol panel 42 can be switched between the reflective mode and the transmitting mode to selectively reflect at least part of the infrared light back to the electronic device, thereby increasing the utilization rate of the infrared light and improving energy saving efficiency.

In one embodiment of the present disclosure, as shown in FIG. 2A and FIG. 2B, the first cholesterol panel 42 may comprise: a third substrate 421; a fourth substrate 422 disposed opposite to the third substrate 421; and a first cholesteric liquid crystal layer 423 disposed between the third substrate 421 and the fourth substrate 422. The first cholesteric liquid crystal layer 423 may selectively reflect at least part of the infrared light passing through the low emissivity glass 41 back into the electronic device, thereby recycling and reusing the infrared light.

In one embodiment of the present disclosure, the materials of the third substrate 421 and the fourth substrate 422 may be the same or different. The materials of the third substrate 421 and the fourth substrate 422 may be respectively as described for the first substrate 31 and the second substrate 32, and are not described again here. In one embodiment, the first cholesteric liquid crystal layer 423 may be used to reflect at least part of the light with wavelengths between 780 nm and 3000 nm, the material of the first cholesteric liquid crystal layer 423 may comprise a cholesteric liquid crystal, a polymer-stabilized cholesteric texture liquid crystal (PSCT LC), other suitable liquid crystal material or a combination thereof, but the present disclosure is not limited thereto. The first cholesteric liquid crystal layer 423 may comprise at least one liquid crystal sublayer. When the at least one liquid crystal sublayer comprise multiple layers, the liquid crystal sublayers may respectively comprise cholesteric liquid crystal layer with different pitches to achieve the effect of reflecting at least part of the infrared light with broad wavelengths, but the present disclosure is not limited thereto. In one embodiment of the present disclosure, the first cholesteric liquid crystal layer 423 may be used to reflect at least part of left-handed infrared light or right-handed infrared light. For example, when the first cholesteric liquid crystal layer 423 is used to reflect at least part of the left-handed infrared light, at least part of the right-handed infrared light may pass through the first cholesteric liquid crystal layer 423. On the contrary, when the first cholesteric liquid crystal layer 423 is used to reflect at least part of the right-handed infrared light, at least part of the left-handed infrared light may pass through the first cholesteric liquid crystal layer 423.

In one embodiment of the present disclosure, as shown in FIG. 2A and FIG. 2B, the first cholesterol panel 42 may comprise a sealing element S2 disposed surrounding the first cholesteric liquid crystal layer 423.

In one embodiment of the present disclosure, even not shown in the figure, the first cholesterol panel 42 may selectively comprise an electrode layer, a conductive line, an alignment layer, a spacer, an active element, a passive element, or other suitable components, and any material known in the art can be used to prepare the aforesaid components and is not described again here. In one embodiment of the present disclosure, voltage may be applied or not applied to the electrode layer (not shown in the figure) of the first cholesterol panel 42 to control the arrangement direction of the cholesterol liquid crystal 4231 in the first cholesteric liquid crystal layer 423, thereby controlling the first cholesterol panel 42 switching between the reflective mode and the transmitting mode. When the cholesterol liquid crystal 4231 in the first cholesteric liquid crystal layer 423 is arranged in a planer state, at least part of the infrared light (for example, the left-handed or the right-handed infrared light) may be, for example, reflected by the first cholesteric liquid crystal layer 423 and the first cholesterol panel 42 is in the reflective mode. When the long axis of the cholesterol liquid crystal 4231 in the first cholesteric liquid crystal layer 423 is arranged approximately vertical to the surface of the third substrate 421 (or the surface of the fourth substrate 422), at least part of the infrared light may pass through the first cholesteric liquid crystal layer 423, and the first cholesterol panel 42 is in the transmitting mode.

In one embodiment of the present disclosure, even not shown in the figure, an adhesive layer may be selectively comprised between the low emissivity glass 41 and the first cholesterol panel 42 to fix the low emissivity glass 41 and the first cholesterol panel 42. The material of the adhesive layer may comprise polyvinyl butyral (PVB), ethylene vinyl acetate (PVB), ethylene vinyl acetate (EVA), optical clear adhesive (OCA), optical clear resin (OCR), other suitable materials or a combination thereof, but the present disclosure is not limited thereto.

In one embodiment of the present disclosure, even not shown in the figure, the substrate 411 of the low emissivity glass 41 may be selectively omitted. In other words, the coating layer 412 of the low emissivity glass 41 may be disposed on the third substrate 421, that is, the coating layer 412 may be disposed on one side of the third substrate 421 adjacent to the light modulation element 3. In other embodiments (not shown in the figure), the coating layer 412 may be respectively disposed on two sides of the third substrate 421. The material of the coating layer 412 comprises but not limited to silver, aluminum, an alloy thereof or a combination thereof. The coating layer 412 may be composed of single layer, double layers, or greater than two layers of the coating materials, and the materials of each coating layers may be the same or different.

The following will describe in detail the situation in which infrared light passes through the electronic device when the first cholesterol panel 42 is in the reflective mode and the transmitting mode. In FIG. 2A and FIG. 2B, the horizontal bidirectional arrow represents horizontally polarized light, the vertical bidirectional arrow represents vertically polarized light, and the ellipse represents elliptically polarized light. In the following embodiments, only the infrared light is used for explanation. The incident light L comprises the infrared light L1, UV light and/or visible light. The reflective polarizing element 1 may be, for example, used to reflect approximately about 50% of the infrared light (i.e. the infrared light approximately parallel to the reflection axis RA of the reflective polarizing element 1) and allow about 50% of the infrared light (i.e. the infrared light parallel to the transmitting axis RA of the reflective polarizing element 1) to pass through. The low emissivity glass 41 may be used to reflect about 70% of the infrared light and allow 30% of the infrared light to pass through. But, the present disclosure is not limited thereto. For example, the first cholesteric liquid crystal layer 423 may be used to reflect 50% of the infrared light (for example, one of the left-handed infrared light and the right-handed infrared light), and allow 50% of the infrared light (for example, the other of the left-handed infrared light and the right-handed infrared light) to pass through, but the present disclosure is not limited thereto. In the present embodiment, the first cholesteric liquid crystal layer 423 may be used, for example, to reflect at least part of the left-handed infrared light and allow at least part of the right-handed infrared light to pass through the first cholesteric liquid crystal layer 423, but the present disclosure is not limited thereto. In other embodiments, the first cholesteric liquid crystal layer 423 may be used, for example, to reflect at least part of the right-handed infrared light and allow at least part of the left-handed infrared light to pass through the first cholesteric liquid crystal layer 423, but the present disclosure is not limited thereto.

In one embodiment of the present disclosure, when the first cholesterol panel 42 is switched to the reflective mode, as shown in FIG. 2A and FIG. 1B, as the incident infrared light L1 (including horizontally polarized light and vertically polarized light) passes through the reflective polarizing element 1, most of the vertically polarized light parallel to the reflection axis RA of the reflective polarizing element 1 (approximately about 50% of the infrared light L1) can be reflected, and most of the horizontally polarized light parallel to the transmitting axis TA of the reflective polarizing element 1 (approximately about 50% of the incident infrared light L1) may pass through the reflective polarizing element 1 and transmit to the quarter wave plate 2. Next, the horizontally polarized light is affected by the phase retardation of the quarter wave plate 2, and most of the linearly polarized light is converted into the elliptically polarized light. Then, after the elliptically polarized light passes through the light modulation element 3, most of the elliptically polarized light (for example, about 70%, but the present disclosure is not limited thereto, which can be different according to the design of the low emissivity glass 41) may be reflected by the low emissivity glass 41, and a small part of the elliptically polarized light (for example, about 30%, but the present disclosure is not limited thereto, which can be different according to the design of the low emissivity glass 41) may pass through the low emissivity glass 41. Herein, the infrared light reflected back to the light modulation element 3 may be about 35% of the incident infrared light L1, and the infrared light (including the elliptically polarized light) passing through the low emissivity glass 41 and not reflected back to the light modulation element 3 is about 15% of the incident infrared light L1, but the present disclosure is not limited thereto. Then, a part of the elliptically polarized light passing through the low emissivity glass 41 is at least partially reflected by the first cholesterol panel 42 (the first cholesteric liquid crystal layer 423), and a part of the elliptically polarized light passing through the low emissivity glass 41 at least partially passes through the first cholesterol panel 42 (the first cholesteric liquid crystal layer 423). For example, when the first cholesteric liquid crystal layer 423 may be used to reflect at least part of the left-handed infrared light, in the elliptically polarized light passing through the low emissivity glass 41, the first cholesteric liquid crystal layer 423 may be used to reflect at least part of the left-handed infrared light, and at least part of the right-handed infrared light may pass through the first cholesteric liquid crystal layer 423 and not be reflected. The left-handed infrared light reflected by the first cholesteric liquid crystal layer 423, for example, is about 7.5% of the incident infrared light L1, and the right-handed infrared light passing through the first cholesteric liquid crystal layer 423, for example, is about 7.5% of the incident infrared light L1, but the present disclosure is not limited thereto. It can be seen from this that, the first cholesterol panel 42 (the first cholesteric liquid crystal layer 423) may be used to increase the infrared light in the electronic device, thereby increasing the utilization rate of the infrared light.

Then, at least part of the reflected left-handed infrared light and the reflected elliptically polarized light may pass through the light modulation element 3 and the quarter wave plate 2 in sequence. At least part of the left-handed infrared light and the elliptically polarized light again passing through the quarter wave plate 2 are affected by the phase retardation of the quarter wave plate 2, and at least part of them are converted into the non-linear polarized light. Next, the light approximately parallel to the transmitting axis TA of the reflective polarizing element 1 in the non-linear polarized light may at least partially pass through the reflective polarizing element 1, and the light approximately parallel to the reflection axis RA of the reflective polarizing element 1 may be at least partially reflected and remain in the lamination structure of the electronic device (for example, the quarter wave plate 2, the light modulation element 3, the low emissivity glass 41 and/or the first cholesterol panel 42). Thus, at least part of the infrared light can be left inside the electronic device for continuous circulation, thereby improving the utilization rate of light. Therefore, at least part of the liquid crystal material 331 in the light modulation element 3 may be continuously heated by the infrared light. Even no heating device is additionally provided, at least part of the liquid crystal material 331 is maintained within the operating temperature range, thereby achieving the purpose of energy saving.

In one embodiment of the present disclosure, when the first cholesterol panel 42 is switched to the transmitting mode, as shown in FIG. 2B, at least part of the incident infrared light L1 (including the horizontally polarized light and the vertically polarized light) may pass through the reflective polarizing element 1, the quarter wave plate 2, the light modulation element 3 and the low emissivity glass 41 in sequence. Most of the elliptically polarized light may be reflected by the low emissivity glass 41, and a small part of the elliptically polarized light may pass through the low emissivity glass 41. The reflected elliptically polarized light may be about 35% of the incident infrared light L1, and the passing elliptically polarized light may be about 15% of the incident infrared light L1, but the present disclosure is not limited thereto. Then, since the first cholesterol panel 42 is switched to the transmitting mode, most of the elliptically polarized light passing through the low emissivity glass 41 may be, for example, at least partially pass through the first cholesterol panel 42 (the first cholesteric liquid crystal layer 423), to transmit appropriate infrared light to the side far away from the light incident side to control the temperature of the environment where the electronic device is located.

Next, at least part of the elliptically polarized light reflected by the low emissivity glass 41 may pass through the light modulation element 3 and the quarter wave plate 2 in sequence. The light again passing through the quarter wave plate 2 may be affected by the phase retardation, and at least part of the elliptically polarized light is converted into the non-linear polarized light. Then, the light approximately parallel to the transmitting axis TA of the reflective polarizing element 1 in the non-linear polarized light may, for example, at least partially pass through the reflective polarizing element 1 and not be reflected, and the light approximately parallel to the reflection axis RA of the reflective polarizing element 1 may be at least partially reflected and remain in the lamination structure of the electronic device, and at least part of the light may again pass through the quarter wave plate 2, the light modulation element 3, the low emissivity glass 41 and the first cholesterol panel 42 in sequence. Thus, at least part of the infrared light may be left inside the electronic device and circulate continuously, thereby improving the utilization rate of light.

FIG. 2C is a schematic view showing the IR reflective mode of an electronic device according to one embodiment of the present disclosure. FIG. 2D is a schematic view showing the IR transmitting mode of an electronic device according to one embodiment of the present disclosure. The electronic device of FIG. 2C is similar to that of FIG. 2A, and the electronic device of FIG. 2D is similar to that of FIG. 2B, except for the following differences.

In one embodiment of the present disclosure, as shown in FIG. 2C and FIG. 2D, the infrared light reflective element comprises: a low emissivity glass 41; and a first cholesterol panel 42 (including the first cholesteric liquid crystal layer 423) disposed opposite to the low emissivity glass 41, wherein the first cholesterol panel 42 (including the first cholesteric liquid crystal layer 423) is disposed between the low emissivity glass 41 and the light modulation element 3. The first cholesterol panel 42 may be switched between the reflective mode and the transmitting mode to selectively reflect at least part of the infrared light back to and left in the electronic device, thereby improving the utilization rate of the infrared light and improving energy saving efficiency, but the present disclosure is not limited thereto.

In the present disclosure, the detail structure of the first cholesterol panel 42 may be as described above and is not described again here. In addition, the materials of the third substrate 421, the fourth substrate 422, the first cholesteric liquid crystal layer 423 and the sealing element S2 may be as described above, and are not described again here. The infrared light reflective element 4 comprises the first cholesteric liquid crystal layer 423 of the first cholesterol panel 42, the first cholesteric liquid crystal layer 423 is disposed between the low emissivity glass 41 and light modulation element 3, wherein the first cholesteric liquid crystal layer 423 is used to reflect at least part of light with wavelengths between 780 nm and 3000 nm (780 nm≤wavelength≤3000 nm). The first cholesteric liquid crystal layer 423 may selectively reflect at least part of the infrared light passing through the light modulation element 3 back to the electronic device, so at least part of the infrared light can be continuously recycled and reused in the electronic device.

In one embodiment of the present disclosure, even not shown in the figure, an adhesive layer may be selectively included between the first cholesterol panel 42 and the light modulation element 3, and another adhesive layer may be selectively included between the first cholesterol panel 42 and the low emissivity glass 41 to adhere the light modulation element 3 and the low emissivity glass 41 respectively located at two sides of the first cholesterol panel 42 with the first cholesterol panel 42. The material of the two adhesive layers may be referred to above.

The situation in which the infrared light passes through the electronic device when the first cholesterol panel 42 is in the reflective mode and the transmitting mode will be described in detail below. In FIG. 2C and FIG. 2D, horizontal bidirectional arrows represent horizontally polarized light, vertical bidirectional arrows represent vertically polarized light, and ellipses represent elliptically polarized light. In the following embodiments, only the infrared light is used for explanation. The incident light L comprises the infrared light L1, UV light and/or visible light. The reflective polarizing element 1 may, for example, reflect about 50% of the infrared light and allow about 50% of the infrared light to pass through, but the present disclosure is not limited thereto. The low emissivity glass 41 may reflect, for example, about 70% of the infrared light and allow about 30% of the infrared light to pass through. But, the present disclosure is not limited thereto. For example, the first cholesteric liquid crystal layer 423 may reflect about 50% of the infrared light and allow about 50% of the infrared light to pass through, but the present disclosure is not limited thereto. In the present embodiment, the first cholesteric liquid crystal layer 423 may, for example, reflect at least part of the left-handed infrared light, and at least part of the right-handed infrared light may pass through the first cholesteric liquid crystal layer 423, but the present disclosure is not limited thereto.

In one embodiment of the present disclosure, when the first cholesterol panel 42 is switched to the reflective mode, as shown in FIG. 2C and FIG. 1B, as the incident infrared light L1 (including the horizontally polarized light and the vertically polarized light) passes through the reflective polarizing element 1, the vertically polarized light approximately parallel to the reflection axis RA of the reflective polarizing element 1 (about 50% of the incident infrared light L1) for example, is reflected, and the horizontally polarized light approximately parallel to the transmitting axis TA of the reflective polarizing element 1 (about 50% of the incident infrared light L1) for example, passes through the reflective polarizing element 1 to achieve the quarter wave plate 2. Then, the horizontally polarized light (infrared light) passing through the reflective polarizing element 1 is affected by the phase retardation of the quarter wave plate 2, and at least part thereof is converted from the linearly polarized light to the elliptically polarized light approximately. Then, after the elliptically polarized light passes through the light modulation element 3, a part of the elliptically polarized light is reflected by the first cholesterol panel 42 (the first cholesteric liquid crystal layer 423), and another part of the elliptically polarized light passes through the first cholesterol panel 42 (the first cholesteric liquid crystal layer 423). More specifically, in the elliptically polarized light passing through the light modulation element 3, the first cholesteric liquid crystal layer 423 may be used to reflect at least part of the left-handed infrared light, and at least part of the right-handed infrared light may pass through the first cholesteric liquid crystal layer 423. The reflected left-handed infrared light is about 25% of the incident infrared light L1, and the passing right-handed infrared light is about 25% of the incident infrared light L1, but the present disclosure is not limited thereto. Then, most of the right-handed infrared light passing through the first cholesterol panel 42 (the first cholesteric liquid crystal layer 423) (about 17.5% of the incident infrared light L1) for example, is reflected by the low emissivity glass 41, and a small part of the right-handed infrared light (about 7.5% of the incident infrared light L1) may pass through the low emissivity glass 41. It can be seen from this that, the first cholesterol panel 42 (the first cholesteric liquid crystal layer 423) can be used to increase the amount of the infrared light remained inside electronic device to improve the utilization of the infrared light.

Then, at least part of the left-handed infrared light reflected by the first cholesterol panel 42 (the first cholesteric liquid crystal layer 423) and the right-handed infrared light reflected by the low emissivity glass 41, for example, pass through the light modulation element 3 and the quarter wave plate 2 in sequence. The left-handed infrared light and the right-handed infrared light passing through the quarter wave plate 2 is affected, for example, by the phase retardation of the quarter wave plate 2 and at least part of them are converted into the non-linear polarized light. Then, the light approximately parallel to the transmitting axis TA of the reflective polarizing element 1 in the non-linear polarized light, for example, at least partially passes through the reflective polarizing element 1 and is not reflected, and the light approximately parallel to the reflection axis RA of the reflective polarizing element 1 may be at least partially reflected and remain in the lamination structure of the electronic device, followed by passing through the quarter wave plate 2, the light modulation element 3, the first cholesterol panel 42 and the low emissivity glass 41 in sequence. Thus, a part of the infrared light can be left inside the electronic device and continuously circulate. Therefore, when there is external light, the liquid crystal material 331 of the light modulation element 3 can be continuously heated by the infrared light. Even no heating device is additionally provided, at least part of the liquid crystal material 331 is maintained within the operating temperature range to achieve energy saving.

In one embodiment of the present disclosure, when the first cholesterol panel 42 is switched to the transmitting mode, as shown in FIG. 2D, at least part of the incident infrared light L1 (including the horizontally polarized light and the vertically polarized light) for example, pass through the reflective polarizing element 1, the quarter wave plate 2 and the light modulation element 3 in sequence and converted into the elliptically polarized light. When the first cholesterol panel 42 is switched to the transmitting mode, at least part of the elliptically polarized light (infrared light) may pass through the first cholesterol panel 42 (the first cholesteric liquid crystal layer 423) and transmit to the low emissivity glass 41. Then, at least part of the elliptically polarized light is reflected by the low emissivity glass 41, and at least part of the elliptically polarized light passes through the low emissivity glass 41. The reflected elliptically polarized light is about 35% of the incident infrared light L1, and the passing elliptically polarized light is about 15% of the incident infrared light L1, but the present disclosure is not limited thereto.

Then, the elliptically polarized light reflected by the low emissivity glass 41 at least partially, for example, passes through the first cholesterol panel 42 (the first cholesteric liquid crystal layer 423), the light modulation element 3 and the quarter wave plate 2. At least part of the light passing through the quarter wave plate 2, for example, is affected by the phase retardation, and at least part of the elliptically polarized light is converted into the non-linear polarized light. Then, the light approximately parallel to the transmitting axis TA of the reflective polarizing element 1 in the non-linear polarized light, for example, passes through the reflective polarizing element 1 and is not reflected, and the light approximately parallel to the reflection axis RA of the reflective polarizing element 1 may be at least partially reflected and remain in the lamination structure of the electronic device. At least part of the infrared light can remain inside the electronic device for continuous circulation, thereby improving light utilization.

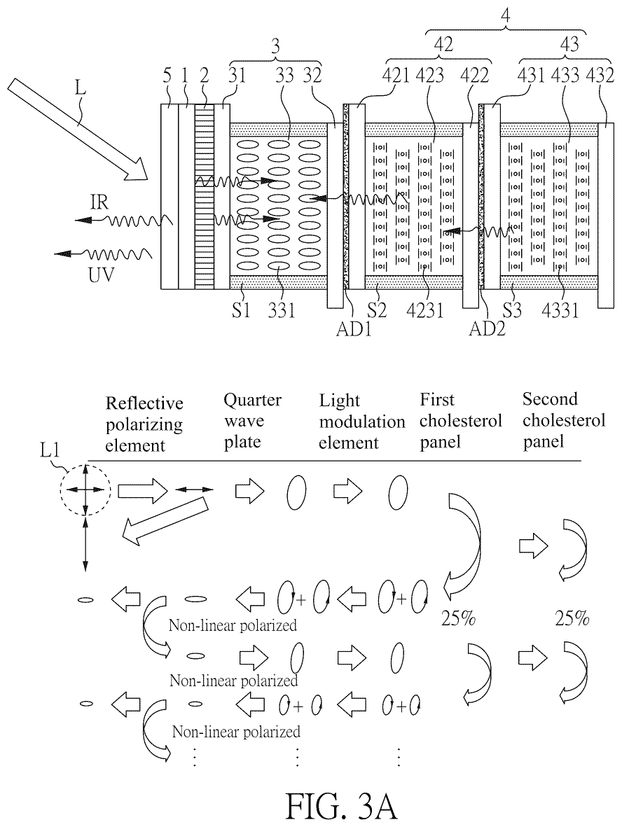

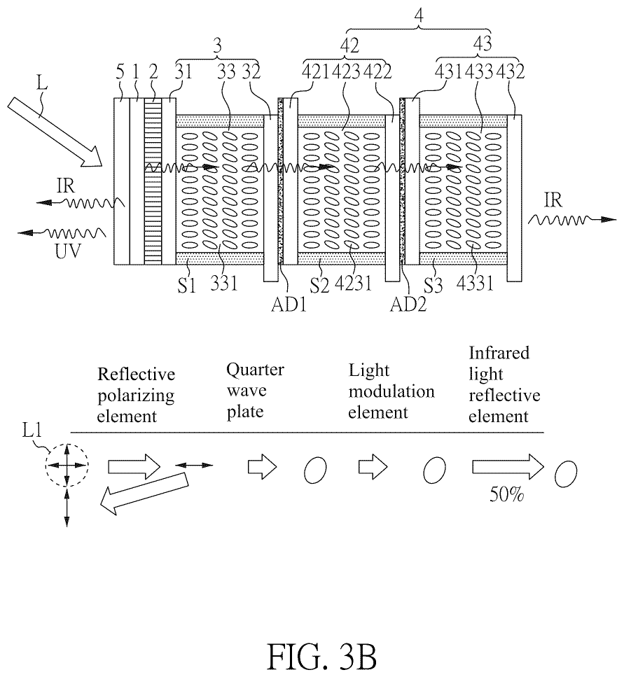

FIG. 3A is a schematic view showing the IR reflective mode of an electronic device according to one embodiment of the present disclosure. FIG. 3B is a schematic view showing the IR transmitting mode of an electronic device according to one embodiment of the present disclosure. The electronic device of FIG. 3A and FIG. 3B is similar to that of FIG. 1A, except for the following differences.

In one embodiment of the present disclosure, as shown in FIG. 3A and FIG. 3B, the infrared light reflective element 4 comprises: a first cholesterol panel 42; and a second cholesterol panel 43 disposed opposite to the first cholesterol panel 42, wherein the first cholesterol panel 42 is disposed between the second cholesterol panel 43 and the light modulation element 3. The first cholesterol panel 42 and the second cholesterol panel 43 may be respectively switched between the reflective mode and the transmitting mode to selectively reflect at least part of the infrared light. Thus, at least part of the infrared light can be circulated in the electronic device, which can improve the utilization rate of light and improve energy saving efficiency.

In the present disclosure, the detail structure of the first cholesterol panel 42 may be as described above and is not described again here. The materials of the third substrate 421, the fourth substrate 422, the first cholesteric liquid crystal layer 423 and the sealing element S2 may also as described above and are not described again here. In the present disclosure, the first cholesteric liquid crystal layer 423 may be used to reflect at least part of light with wavelength between 780 nm and 3000 nm, and the first cholesteric liquid crystal layer 423 may selectively reflect at least part of the infrared light passing through the light modulation element 3, so at least part of the infrared light may be circulated and reused in the electronic device. The second cholesteric liquid crystal layer 433 may be used to reflect at least part of light with wavelength between 780 nm and 3000 nm, and the first cholesteric liquid crystal layer 423 and the second cholesteric liquid crystal layer 433 may be used to reflect light with different optical rotations. For example, when the first cholesteric liquid crystal layer 423 is used to reflect at least part of the left-handed infrared light, and the second cholesteric liquid crystal layer 433 may be used to reflect at least part of the right-handed infrared light. Similarly, when the first cholesteric liquid crystal layer 423 is used to reflect at least part of the right-handed infrared light, and the second cholesteric liquid crystal layer 433 may be used to reflect at least part of the left-handed infrared light. But, the present disclosure is not limited thereto.

In other embodiments, the first cholesteric liquid crystal layer 423 and the second cholesteric liquid crystal layer 433 may also be used to reflect light with the same light rotation (the light with wavelengths between 780 nm and 3000 nm).

In one embodiment of the present disclosure, as shown in FIG. 3A and FIG. 3B, the second cholesterol panel 43 may comprise: a fifth substrate 431; a sixth substrate 432 disposed opposite to the fifth substrate 431; and a second cholesteric liquid crystal layer 433 disposed between the fifth substrate 431 and the sixth substrate 432. The second cholesteric liquid crystal layer 433 may selectively reflect at least part of the infrared light passing through the first cholesterol panel 42 to the electronic device, thereby circulating and recycling at least part of the infrared light.

In one embodiment of the present disclosure, the materials of the fifth substrate 431 and the sixth substrate 432 may be the same or different, and the materials of the fifth substrate 431 and the sixth substrate 432 may be as described for the first substrate 31 and the second substrate 32 respectively and are not described again here. In one embodiment of the present disclosure, the same or different materials of the first cholesteric liquid crystal layer 423 may be used to prepare the second cholesteric liquid crystal layer 433, and the material of the second cholesteric liquid crystal layer 433 may be as described for the first cholesteric liquid crystal layer 423 and is not described again here.

In one embodiment of the present disclosure, as shown in FIG. 3A and FIG. 3B, the second cholesterol panel 43 may comprise a sealing element S3 disposed surrounding the second cholesteric liquid crystal layer 433.

In one embodiment of the present disclosure, even not shown in the figure, the first cholesterol panel 42 and the second cholesterol panel 43 may selectively comprise an electrode layer, a conductive line, an alignment layer, a spacer, an active element, a passive element or other suitable elements respectively, and any material known in the art can be used to prepare the aforesaid elements and is not described again here. In one embodiment of the present disclosure, voltage may be applied or not applied to the electrodes (not shown in the figure) in the first cholesterol panel 42 and the second cholesterol panel 43 respectively to control the arrangement directions of the cholesterol liquid crystal 4231 of the first cholesteric liquid crystal layer 423 and the cholesterol liquid crystal 4331 of the second cholesteric liquid crystal layer 433 respectively. Thus, the first cholesterol panel 42 and the second cholesterol panel 43 may be respectively switched between the reflective mode and the transmitting mode. For example, when the cholesterol liquid crystal 4231 in the first cholesteric liquid crystal layer 423 is arranged in the planer state, at least part of the infrared light may be, for example, reflected by the first cholesteric liquid crystal layer 423 so the first cholesterol panel 42 is in the reflective mode. Similarly, when the cholesterol liquid crystal 4331 in the second cholesteric liquid crystal layer 433 is arranged in the planer state, at least part of the infrared light is reflected by the second cholesteric liquid crystal layer 433, and the second cholesterol panel 43 is in the reflective mode. When the long axis direction of the cholesterol liquid crystal 4231 in the first cholesteric liquid crystal layer 423 is arranged approximately vertical to the surface of the third substrate 421 (or the surface of the fourth substrate 422), most of the infrared light may pass through the first cholesteric liquid crystal layer 423, and the first cholesterol panel 42 is in the transmitting mode. Similarly, when the long axis of the cholesterol liquid crystal 4331 in the second cholesteric liquid crystal layer 433 is arranged approximately vertical to the surface of the fifth substrate 431 (or the surface of the sixth substrate 432), most of the infrared light may pass through the second cholesteric liquid crystal layer 433 and the second cholesterol panel 43 is in the transmitting mode.

In one embodiment of the present disclosure, as shown in FIG. 3A and FIG. 3B, an adhesive layer AD1 may be selectively included between the first cholesterol panel 42 and the light modulation element 3, and another adhesive layer AD2 may be selectively included between the first cholesterol panel 42 and the second cholesterol panel 43. The adhesive layer AD1 and the adhesive layer AD2 may comprise the same or different materials, and suitable materials include polyvinyl butyral (PVB), ethylene vinyl acetate (EVA), optical clear adhesive (OCA), optical clear resin (OCR), other suitable material or a combination thereof, but the present disclosure is not limited thereto.

The following will describe in detail the situation in which infrared light passes through the electronic device when the first cholesterol panel 42 and the second cholesterol panel 43 are in the reflective mode and the transmitting mode respectively. In FIG. 3A and FIG. 3B, the horizontal bidirectional arrow represents horizontally polarized light, the vertical bidirectional arrow represents vertically polarized light, and the ellipse represents elliptically polarized light. In the following embodiments, only the infrared light is used for explanation. The incident light L comprises infrared light L1, UV light and visible light. The reflective polarizing element 1 may be used, for example, to reflect about 50% of the infrared light and allow 50% of the infrared light to pass through, but the present disclosure is not limited thereto. The first cholesteric liquid crystal layer 423 may be, for example, used to reflect about 50% of the infrared light (for example, one of the left-handed light and the right-handed light), and allow about 50% of the infrared light (including the other one of the left-handed light and the right-handed light) to pass through, but the present disclosure is not limited thereto. The second cholesteric liquid crystal layer 433 may be used, for example, to reflect about 50% of the infrared light (for example, the other one of the left-handed light and the right-handed light) and allow about 50% of the infrared light (for example, one of the left-handed light and the right-handed light) to pass through, but the present disclosure is not limited thereto. In the present embodiment, the first cholesteric liquid crystal layer 423, for example, may be used to reflect most of the left-handed infrared light, and most of the right-handed infrared light may pass through the first cholesteric liquid crystal layer 423; the second cholesteric liquid crystal layer 433 may be, for example, used to reflect most of the right-handed infrared light, and most of the left-handed infrared light may pass through the second cholesteric liquid crystal layer 433; but the present disclosure is not limited thereto. In other embodiments, the first cholesteric liquid crystal layer 423 may be, for example, used to reflect most of the right-handed infrared light, and most of the left-handed infrared light may pass through the first cholesteric liquid crystal layer 423; the second cholesteric liquid crystal layer 433 may be, for example, used to reflect most of the left-handed infrared light, and most of the right-handed infrared light may pass through the second cholesteric liquid crystal layer 433; but the present disclosure is not limited thereto.

In one embodiment of the present disclosure, when the first cholesterol panel 42 is switched to the reflective mode and the second cholesterol panel 43 is also switched to the reflective mode, as shown in FIG. 3A and FIG. 1B, as the incident infrared light L1 (including the horizontally polarized light and the vertically polarized light) passes through the reflective polarizing element 1, the vertically polarized light approximately parallel to the reflection axis RA of the reflective polarizing element 1 (about 50% of the incident infrared light L1) for example, is reflected, and the horizontally polarized light approximately parallel to the transmitting axis TA of the reflective polarizing element 1 (about 50% of the incident infrared light L1) for example, passes through reflective polarizing element 1 and is transmitted to the quarter wave plate 2. Then, the horizontally polarized light is, for example, affected by the phase retardation of the quarter wave plate 2, and most of the horizontally polarized light (the linearly polarized light) may be converted into the elliptically polarized light, followed by passing through the light modulation element 3. Then, the elliptically polarized light passing through the light modulation element 3 is, for example, partially reflected by the first cholesterol panel 42, and part of the elliptically polarized light is reflected by the second cholesterol panel 43. For example, the first cholesteric liquid crystal layer 423 may be used to reflect at least part of the left-handed infrared light, and the second cholesteric liquid crystal layer 433 may be used to reflect at least part of the right-handed infrared light. Thus, when the elliptically polarized light passing through the light modulation element 3 passes through the first cholesterol panel 42, most of the left-handed infrared light is, for example, reflected by the first cholesteric liquid crystal layer 423, most of the right-handed infrared light passes through the first cholesteric liquid crystal layer 423, and the right-handed light passing through the first cholesterol panel 42 is, for example, reflected by the second cholesteric liquid crystal layer 433 and back to the electronic device. Herein, the left-handed infrared light reflected by the first cholesterol panel 42 is about 25% of the incident infrared light L1, and the right-handed infrared light reflected by the second cholesterol panel 43 is about 25% of the incident infrared light L1. Through the above design, the amount of the infrared light left in the electronic device can be increase, thereby improving the light utilization.

Next, the reflected left-handed infrared light and right-handed infrared light may at least partially pass through the light modulation element 3 and/or the quarter wave plate 2 in sequence again. The left-handed infrared light and the right-handed infrared light again passing through the quarter wave plate 2 is, for example, affected by the phase retardation of the quarter wave plate 2, and at least partially converted into the non-linear polarized light. Then, most of the light approximately parallel to the transmitting axis TA of the reflective polarizing element 1 in the non-linear polarized light, for example, passes through the reflective polarizing element 1 and not be reflected, and the light parallel to the reflection axis RA of the reflective polarizing element 1 may be at least partially reflected and left in the lamination structure of the electronic device, followed by again passing through the quarter wave plate 2, the light modulation element 3, the first cholesterol panel 42 and the second cholesterol panel 43 in sequence. Thus, at least part of the infrared light is, for example, left inside the electronic device and circulates continuously. Therefore, at least part of the liquid crystal material 331 of the light modulation element 3 can be continuously heated by the infrared light. Even no heating device is additionally provided, the liquid crystal material 331 is maintained within the operating temperature range to achieve energy saving.

In one embodiment of the present disclosure, when the first cholesterol panel 42 is switched to the transmitting mode and the second cholesterol panel 42 is switched to the transmitting mode, as shown in FIG. 3B, at least part of the incident infrared light L1 (including the horizontally polarized light and the vertically polarized light) for example, passes through the reflective polarizing element 1, the quarter wave plate 2 and the light modulation element 3 in sequence and is converted into the elliptically polarized light. Then, since the first cholesterol panel 42 is switched to the transmitting mode and the second cholesterol panel 43 is also switched to the transmitting mode, most of the elliptically polarized light may pass through the first cholesterol panel 42 (the first cholesteric liquid crystal layer 423) and the second cholesterol panel 43 (the second cholesteric liquid crystal layer 433).

In the present disclosure, by combining the reflective polarizing element 1, the infrared light reflective element 4, the quarter wave plate 2 and/or the light modulation element 3, at least part of the infrared light may be left inside the electronic device to circulate and be used. Even no heating device is additionally provided, the chance of maintaining the liquid crystal material within the operating temperature range can be increased to achieve energy saving.

In the present disclosure, the electronic device may be applied to any energy saving device comprising liquid crystal materials, thereby improving the energy saving of the electronic device. In the present disclosure, the electronic device may be applied to, for example, electronic window or other suitable application products, but the present disclosure is not limited thereto.

The above specific embodiments should be construed as merely illustrative without limiting the remainder of the disclosure in any way, and features of different embodiments may be mixed and matched as long as they do not conflict with each other.

Although the present disclosure has been explained in relation to its embodiment, it is to be understood that many other possible modifications and variations can be made without departing from the spirit and scope of the disclosure as hereinafter claimed.

1. A electronic device, comprising:
a reflective polarizing element;
an infrared light reflective element disposed opposite to the reflective polarizing element;
a quarter wave plate disposed between the reflective polarizing element and the infrared light reflective element; and
a light modulation element disposed between the quarter wave plate and the infrared light reflective element.

2. The electronic device of claim 1, wherein the light modulation element comprises:
a first substrate;
a second substrate disposed opposite to the first substrate; and
a light modulation layer disposed between the first substrate and the second substrate and comprising a liquid crystal material and a dye material.

3. The electronic device of claim 1, wherein an angle is included between a transmitting axis of the reflective polarizing element and a fast axis of the quarter wave plate, and the angle is greater than 0° and less than 45° or the angle is greater than 45° and less than 90°.

4. The electronic device of claim 1, wherein a reflectivity of the infrared light reflective element to light with wavelengths between 780 nm and 3000 nm is greater than or equal to 70%.

5. The electronic device of claim 1, wherein the infrared light reflective element comprises a low emissivity glass.

6. The electronic device of claim 5, wherein a transmittance of the low emissivity glass to light with wavelengths between 780 nm and 3000 nm is between 5% and 35%.

7. The electronic device of claim 5, wherein a transmittance of the low emissivity glass light with wavelengths between 380 nm and 760 nm is between 50% and 90%.

8. The electronic device of claim 5, wherein the low emissivity glass comprises a coating layer used to reflect at least part of light with wavelengths between 780 nm and 3000 nm.

9. The electronic device of claim 5, wherein the infrared light reflective element further comprise a first cholesteric liquid crystal layer, and the low emissivity glass is disposed between the first cholesteric liquid crystal layer and the light modulation element, wherein the first cholesteric liquid crystal layer is used to reflect at least part of light with wavelengths between 780 nm and 3000 nm.

10. The electronic device of claim 9, wherein the infrared light reflective element further comprises a first cholesterol panel disposed opposite to the low emissivity glass, and the first cholesterol panel comprises:
a third substrate;
a fourth substrate disposed opposite to the third substrate; and
the first cholesteric liquid crystal layer disposed between the third substrate and the fourth substrate.

11. The electronic device of claim 5, wherein the infrared light reflective element further comprise a first cholesteric liquid crystal layer disposed between the low emissivity glass and the light modulation element, and the first cholesteric liquid crystal layer is used to reflect at least part of light with wavelengths between 780 nm and 3000 nm.

12. The electronic device of claim 11, wherein the infrared light reflective element further comprises a first cholesterol panel disposed opposite to the low emissivity glass, and the first cholesterol panel comprises:
a third substrate;
a fourth substrate disposed opposite to the third substrate; and
the first cholesteric liquid crystal layer disposed between the third substrate and the fourth substrate.

13. The electronic device of claim 1, wherein the infrared light reflective element further comprises a first cholesteric liquid crystal layer and a second cholesteric liquid crystal layer, and the first cholesteric liquid crystal layer is disposed between the second cholesteric liquid crystal layer and the light modulation element, wherein the first cholesteric liquid crystal layer and the second cholesteric liquid crystal layer are used to reflect at least part of light with wavelengths between 780 nm and 3000 nm, and the first cholesteric liquid crystal layer and the second cholesteric liquid crystal layer are used to reflect light with different optical rotations.

14. The electronic device of claim 13, wherein the infrared light reflective element further comprises: a first cholesterol panel; and a second cholesterol panel disposed opposite to the first cholesterol panel, wherein the first cholesterol panel is disposed between the second cholesterol panel and the light modulation element.

15. The electronic device of claim 14, wherein the first cholesterol panel comprises:
a third substrate;
a fourth substrate disposed opposite to the third substrate; and
the first cholesteric liquid crystal layer disposed between the third substrate and the fourth substrate.

16. The electronic device of claim 14, wherein the second cholesterol panel comprises:
a fifth substrate;
a sixth substrate disposed opposite to the fifth substrate; and
a second cholesteric liquid crystal layer disposed between the fifth substrate and the sixth substrate.

17. The electronic device of claim 1, wherein the light modulation element comprises a liquid crystal material capable of switching between the transmitting state and the scattering state.

18. The electronic device of claim 1, wherein the light modulation element comprises a liquid crystal material and a dye material.

19. The electronic device of claim 1, further comprising an optical element, wherein the reflective polarizing element is disposed between the optical element and the light modulation element, and the optical element comprises an anti-UV coating layer.

20. The electronic device of claim 1, wherein a reflectivity of the reflective polarizing element to light with wavelengths between 780 nm and 3000 nm is between 5% and 50%.
